(19) United States
(12) Patent Application Publication
(10) Pub. No.: US 2026/0075463 A1
(43) Pub. Date: Mar. 12, 2026

(54) Methods, Devices, and Computer Readable Storage Medium for Communication

(71) Applicant: Huawei Technologies Co., Ltd., Shenzhen (CN)

(72) Inventors: Rojan Chitrakar, Singapore (SG); Lei Huang, Singapore (SG); Kuan Wu, Shenzhen (CN); Yunbo Li, Shenzhen (CN)

(73) Assignee: Huawei Technologies Co., Ltd., Shenzhen (CN)

(21) Appl. No.: 19/343,872

(22) Filed: Sep. 29, 2025

Related U.S. Application Data
(63) Continuation of application No. PCT/CN2023/085220, filed on Mar. 30, 2023.

(51) Int. Cl. H04W 28/06; H04L 5/00; H04W 48/10

(52) U.S. Cl. CPC H04W 28/06; H04L 5/0046; H04W 48/10

(57) ABSTRACT

In an example method, a first terminal device assigns a first subset of blocks in a set of blocks of a block-based time structure to a second device or a set of devices including the second device; and transmits to the second device, an indication message indicating that the first subset of blocks are assigned to the second device or the set of devices.

### CROSS-REFERENCE TO RELATED APPLICATIONS

This is a continuation of International Patent Application PCT/CN2023/085220 filed on Mar. 30, 2023, the disclosure of which is hereby incorporated by reference in its entirety.

### FIELD

Example embodiments of the present disclosure generally relate to the field of telecommunication, and in particular, to methods, devices and a computer readable storage medium for communication.

### BACKGROUND

In communication technique such as ultra-wide band (UWB) technology, several different applications can be allocated in the same block-based frame structure, and different blocks can be assigned to different applications. It is needed to improve the allocation efficiency, and to save power for the devices in the communication.

### SUMMARY

In general, example embodiments of the present disclosure provide a solution for communication.

In a first aspect, there is provided a method performed by a first device. The method comprises: assigning, at a first device, a first subset of blocks in a set of blocks of a block-based time structure to a second device or a set of devices including the second device; and transmitting, to the second device, an indication message indicating that the first subset of blocks is assigned to the second device or the set of devices. This way, the second device or set of devices can know the assigned subset of blocks, and avoids power waste in listening all the blocks.

In some embodiments of the present disclosure, a position of the first round in a first block in the first subset of blocks is same or different from a position of the second round in a second block in the first or next subset of blocks, and the first round and the second round are allocated to the second device. This way, the interference can be avoided with round hopping, or implement the communication easily without round hopping.

In some embodiments of the present disclosure, the first subset of blocks and a second subset of blocks are in a first hyper block and a second hyper block respectively, wherein each of the first hyper block and the second hyper block includes a plurality of blocks; and a position of the first subset of blocks in the first hyper block is the same as a position of the second subset of blocks in the second hyper block. This way, the subset of blocks is fixed allocated in the hyper block, and simply implementation.

In some embodiments of the present disclosure, the first device further transmits one or more of the following items to the second device in a first block among the first subset of blocks: an index of a second block among the first or second subset of blocks; or the number of rounds in the second block among the first or second subset of blocks. This way, the subset of blocks can be assigned clearly.

In some embodiments of the present disclosure, the indication message comprises one or more of the following items: a hyper block index field configured to indicate an index of a hyper block in which the second block is located; a relative block index field configured to indicate a relative index of the second block in the hyper block; a round index field configured to indicate an index of a round in the second block; or a transmission offset field configured to indicate a transmission offset of the round in the second block. This way, the subset of blocks can be assigned with detailed information.

In some embodiments of the present disclosure, the first device further transmits to the second device, an advertising message in a hyper block. The advertising message advertises block assignment to the set of devices, and the block assignment indicates at least one block in the hyper block allocated to the set of devices. Thus, interruption in the communication can be avoided.

In some embodiments of the present disclosure, the advertising message comprises: addresses of the set of devices that are assigned to the subset of blocks in the hyper block, and the number of rounds in a block in the subset of blocks. Thus, the detailed allocation information can be broadcast to set of devices, to avoid interruption in communication.

In some embodiments of the present disclosure, the advertising message comprises one or more of the following items: a block index field configured to indicate the index of the hyper block; a block description list length field configured to indicate the number of block descriptions in a block description list; or a block description list field configured to carry a list of block description field, each block description field carrying information of one block in the hyper block. This way, the detailed allocation information can be broadcast to set of devices, to avoid interruption in communication.

In some embodiments of the present disclosure, the block description field comprises one or more in the following items: a control bitmap field configured to carry bits indicating presence or size of the fields of the block description field; a block duration field configured to indicate the duration of the block in a ranging scheduling time unit (RSTU); a number of rounds field configured to indicate the number of rounds in the block; or a block assignment list configured to indicate a list of block assignments. This way, the blocks can be illustrated clearly, to make the block assignment clear.

In some embodiments of the present disclosure, the block assignment comprises one or more in the following items: an address list field configured to indicate a list of address of the second device or set of devices that are allocated one or more round in the block; an address size field configured to indicate the size used for the addresses in the address list; or an address list length field configured to indicate the number of addresses in the address list. This way, the blocks can be illustrated clearly, to make the block assignment clear.

In some embodiments of the present disclosure, the first device further transmits a poll message to the second device at an indicated start time to initiate a multi-millisecond (MMS) ranging measurement cycle. The poll message comprises one or more in the following items: a hyper block index field configured to indicate an index of the hyper block in which the second block is located; a relative block index field configured to indicate a relative index of the second block in the hyper block; or a number of rounds field configured to indicate the number of rounds in the block indicated by the relative block index field. This way, the poll message can be transmitted for synchronization.

In some embodiments of the present disclosure, the first device receives a response message from the second device, wherein the response message is used for synchronization between the first device and the second device. Thus, synchronization between the first device and the second device can be achieved.

In some embodiments of the present disclosure, the first device further transmits a report (RPRT) message carrying a ranging report to the second device, wherein the RPRT message further carries control information related to the second block. The RPRT message comprises one or more of the following items: a hyper block index field configured to indicate an index of the hyper block in which the second block is located; a relative block index field configured to indicate a relative index of the second block in the hyper block; a block index presence bit configured to indicates whether the hyper block index field and the relative block index fields are present in the RPRT message; a number of rounds presence bit configured to indicate whether a number of rounds field is present in the RPRT message; or the number of rounds field configured to indicate number of rounds in the block indicated by the relative block index field. This way, the report message can carry measurement result and control information at the same time, to improve efficiency.

In some embodiments of the present disclosure, the first device further transmits to the second device, a parameter response (PRM-RESP) message, to update short term operating parameters. The PRM-RESP message comprises at one or more of the following items: a presence control field configured to carry bits to indicate presence or absence of various fields; a block index presence bit configured to indicates whether a hyper block index field and a relative block index field are present in the PRM-RESP message; a number of rounds presence bit configured to indicate whether a number of rounds field is present in the PRM-RESP message; an operating parameters presence bitmap configured to carry bits to indicate presence or absence of various operating parameters related to a session between the first device and the second device; the hyper block index field configured to indicate an index of the hyper block in which the second block is located; the relative block index field configured to indicate a relative index of the second block in the hyper block; the number of rounds field configured to indicate number of rounds in the block indicated by the relative block index field; or the operating parameters field configured to carry various operating parameters related to a session between the first device and the second device. This way, the short-term parameters can be updated efficiently.

In some embodiments of the present disclosure, the first device further receives from the second device, a parameter request (PRM-REQ) message, to request short term operating parameters for the next ranging-measurement cycle. The PRM-REQ message comprises one or more in the following items: an operating parameters presence bitmap configured to carry bits to indicate presence or absence of various operating parameters related to a session between the first device and the second device; or an operating parameters field configured to carry various operating parameters related to the session that the second device is requesting from the first device for the next measurement cycle. This way, the short-term parameters can be updated efficiently.

In some embodiments of the present disclosure, the advertising message comprises one or more in the following items: an address field configured to a broadcast address; a hyper block index field configured to indicate the index of the current hyper block; a block description list configured to carry a list of block description fields, each block description field carrying information of one block of the hyper block; or a block description list length field configured to indicate the number of block description fields in the block description list. This way, interruption in communication can be avoided.

In some embodiments of the present disclosure, a block assignment in the block description field comprises one or more in the following items: an address list field configured to carry a list of short address of the second device or set of devices that are allocated one or more rounds in the block; or an address list length field configured to indicate the number of short addresses in the address list. This way, the devices can be assigned efficiently.

In some embodiments of the present disclosure, the indication message comprises: a ranging round (RR) information element (IE), including a ranging block index field configured to indicate the second block or the index of any future block, in a signaling between the first device and the second device. This way, the second block can be assigned in the first block, to improve flexibility in block assignment.

In some embodiments of the present disclosure, the first device further transmits to the second device, a PRM-RESP message to inform the second block. The PRM-RESP message comprises one or more in the following items: a block index presence bit in a presence control field configured to indicate whether a next block index field is carried in the PRM-RESP message; or the next block index field configured to indicate the index of the second block. This way, the next block can be assigned flexibly.

In some embodiments of the present disclosure, the method is performed for at least one or more in the following applications: ranging; sensing; or time difference of arrival (TDOA). This way, the block-based structure can carry different applications, to improve the flexibility.

In a second aspect, there is provided a method performed by a second device. The method comprises: receiving, at a second device from a first device, an indication message indicating that a first subset of blocks in a set of blocks of a block-based time structure are assigned to the second device or a set of devices including the second device; and participating in a session based on the assigned first subset of blocks. This way, the second device or set of devices can know the assigned subset of blocks, and avoids power waste in listening all the blocks.

In some embodiments of the present disclosure, a position of the first round in a first block in the first subset of blocks is same or different from a position of the second round in a second block in the first or next subset of blocks, the first round and the second round are allocated to the second device. This way, the interference can be avoided with round hopping, or implement the communication easily without round hopping.

In some embodiments of the present disclosure, the first subset of block and a second subset of blocks are in a first hyper block and a second hyper block respectively, wherein each of the first hyper block and the second hyper block includes a plurality of blocks; and a position of the first subset of blocks in the first hyper block is the same as a position of the second subset of blocks in the second hyper block. This way, the subset of blocks is fixed allocated in the hyper block, and simply implementation.

In some embodiments of the present disclosure, the second device further receives one or more in the following items from the first device in the first block among the first subset of blocks: an index of the second block among the first or second subset of blocks, or the number of rounds in the second block among the first or second subset of blocks. The second device calculates the position of the round allocated to it in the second block based on the number of rounds in the second block. This way, the blocks and rounds assignment can be clearer and more efficient.

In some embodiments of the present disclosure, the second device further receives an advertising message in a hyper block from the first device, wherein the advertising message advertises block assignment to the set of devices. The block assignment indicates at least one block in the hyper block allocated to the set of devices. This way, interruption in communication can be avoided.

In some embodiments of the present disclosure, the advertising message comprises: addresses of the set of devices that are assigned to the subset of blocks in the hyper block, and the number of rounds in a block in the subset of blocks. This way, the assignment information can be clear in the advertising message, to make the broadcasting more efficiently

In some embodiments of the present disclosure, the second device further receives a poll message from the first device, at an indicated start time to initiate an MMS ranging measurement cycle. The poll message comprises one or more in the following items: a hyper block index field configured to indicate an index of the hyper block in which the second block is located; a relative block index field configured to indicate a relative index of the second block in the hyper block; or a number of rounds field configured to indicate the number of rounds in the block indicated by the relative block index field. This way, synchronization can be achieved efficiently.

In some embodiments of the present disclosure, the second device further receives from the first device, an RPRT message carrying a ranging report from the first device, wherein the RPRT message further carries control information related to the second block. The RPRT message comprises one or more in the following items: a hyper block index field configured to indicate an index of the hyper block in which the second block is located; a relative block index field configured to indicate a relative index of the second block in the hyper block; a block index presence bit configured to indicates whether the hyper block index field and the relative block index fields are present in the RPRT message; a number of rounds presence bit configured to indicate whether a number of rounds field is present in the RPRT message; or the number of rounds field configured to indicate number of rounds in the block indicated by the relative block index field. This way, control information can be carried in the report message efficiently.

In some embodiments of the present disclosure, the second device further receives from the first device, a PRM-RESP message, to update short term operating parameters. The PRM-RESP message comprises one or more in the following items: a presence control field configured to carry bits to indicate presence or absence of various fields; a block index presence bit configured to indicates whether a hyper block index field and a relative block index field are present in the PRM-RESP message; a number of rounds presence bit configured to indicate whether a number of rounds field is present in the PRM-RESP message; an operating parameters presence bitmap configured to carry bits to indicate presence or absence of various operating parameters related to a session between the first device and the second device; the hyper block index field configured to indicate an index of the hyper block in which the second block is located; the relative block index field configured to indicate a relative index of the second block in the hyper block; the number of rounds field configured to indicate number of rounds in the block indicated by the relative block index field; or the operating parameters field configured to carry various operating parameters related to a session between the first device and the second device. This way, short term parameters can be updated efficiently.

In some embodiments of the present disclosure, the method is performed for one or more in the following applications: ranging; sensing; or TDOA. This way, the block-based structure can carry different applications, to improve flexibility.

In a third aspect, there is provided a first device. The first device comprising: a communications interface; at least one processor coupled to the communications interface; and a memory coupled to the at least one processor and storing programming instructions for execution by the at least one processor, the programming instructions instruct the at least one processor to: assigning, a first subset of blocks in a set of blocks of a block-based time structure to a second device or a set of devices including the second device; and transmitting, by using the communications interface, to the second device, an indication message indicating that the subset of blocks are assigned to the second device or the set of devices. This way, the second device can avoid power waste in listening to all the blocks.

In a fourth aspect, there is provided a second device. The second device comprising: a communications interface; at least one processor coupled to the communications interface; and a memory coupled to the at least one processor and storing programming instructions for execution by the at least one processor, the programming instructions instruct the at least one processor to: receiving, by using the communications interface, from a first device, an indication message indicating that a first subset of blocks in a set of blocks of a block-based time structure are assigned to the second device or a set of devices including the second device; and participating in a session based on the assigned first subset of blocks. This way, the second device can avoid power waste in listening to all the blocks.

In a fifth aspect, there is provided a computer-readable storage medium having instructions stored thereon that, when executed by one or more processors of a computing device, cause the computing device to perform at least the method in the first, and second aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a communication system in which some example embodiments of the present disclosure may be implemented;

FIG. 2 illustrates an example of hyper block structure in which some example embodiments of the present disclosure may be implemented;

FIG. 3 illustrates an example of round hopping in which some example embodiments of the present disclosure may be implemented;

FIG. 4 illustrates an example of round selection scenario in accordance with some example embodiments of the present disclosure may be implemented;

FIG. 5 illustrates a message flow in a UWB session in accordance with some example embodiments of the present disclosure;

FIG. 6 illustrates an example of a process flow with block assignment in accordance with some example embodiments of the present disclosure;

FIG. 7A illustrates an example of same block assignment in hyper blocks in accordance with some example embodiments of the present disclosure;

FIG. 7B illustrates an example of block assignment IE in accordance with some example embodiments of the present disclosure;

FIG. 8A illustrates an example of dynamic block assignment in accordance with some example embodiments of the present disclosure;

FIG. 8B illustrates an example of a data frame in accordance with some example embodiments of the present disclosure;

FIG. 8C illustrates an example of the indication message in accordance with some example embodiments of the present disclosure;

FIG. 9A illustrates an example of the hyper block advertisement round in accordance with some example embodiments of the present disclosure;

FIG. 9B illustrates an example of the hyper block structure information element in accordance with some example embodiments of the present disclosure;

FIG. 9C illustrates an example of content control in accordance with some example embodiments of the present disclosure;

FIG. 9D illustrates an example of block description in accordance with some example embodiments of the present disclosure;

FIG. 9E illustrates an example of block assignment in accordance with some example embodiments of the present disclosure;

FIG. 10A illustrates an example of signaling in MMS ranging in accordance with some example embodiments of the present disclosure;

FIG. 10B illustrates an example of 9 octets POLL message in accordance with some example embodiments of the present disclosure;

FIG. 10C illustrates an example of RPRT message in accordance with some example embodiments of the present disclosure;

FIG. 10D illustrates an example of PRM-RESP message in accordance with some example embodiments of the present disclosure;

FIG. 10E illustrates an example of PRM-REQ message in accordance with some example embodiments of the present disclosure;

FIG. 10F illustrates an example of advanced home base station (ADV-HBS) message in accordance with some example embodiments of the present disclosure;

FIG. 10G illustrates an example of block assignment list in accordance with some example embodiments of the present disclosure;

FIG. 11A illustrates an example of blocks assignment for several applications in accordance with some example embodiments of the present disclosure;

FIG. 11B illustrates an example of RR information element in accordance with some example embodiments of the present disclosure;

FIG. 11C illustrates an example of PRM-RESP message for control signaling in accordance with some example embodiments of the present disclosure;

FIG. 12 illustrates an example of a method implemented at a first device in accordance with some example embodiments of the present disclosure;

FIG. 13 illustrates an example of a method implemented at a second device in accordance with some example embodiments of the present disclosure;

FIG. 14 illustrates a simplified block diagram of a communication device that is suitable for implementing some example embodiments of the present disclosure; and

FIG. 15 illustrates another simplified block diagram of a communication device that is suitable for implementing some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as Long-Term Evolution (LTE), LTE-Advanced (LTE-A), wideband code-division multiple access (WCDMA), High-Speed Packet Access (HSPA), Narrowband Internet of Things (NB-IOT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network function” (NF) refers to a function in 5G core network, including at least one of network slice selection function (NSSF), network exposure function (NEF), network repository function (NRF), policy control function (PCF), unified data management (UDM), unified data repository (UDR), application function (AF), network data analytics function (NWDAF), trusted non-3rd Generation Partnership Project (non-3GPP) gateway function (TNGF), authentication server function (AUSF), access and mobility management function (AMF), session management function (SMF), and user plane function (UPF).

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over Internet Protocol (IP) (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), Universal Serial Bus (USB) dongles, smart devices, wireless customer-premises equipment (CPE), an Internet of Things (IOT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal” may be used interchangeably.

Communication technique such as UWB technology is increasingly being used for indoor positioning and other location services such as access control and asset locating. Aside from dedicated devices and tags, UWB radio is becoming increasingly common in high end smartphones. The UWB physical layer (PHY) and media access control (MAC) layer are standardized by the Institute of Electrical and Electronic Engineers (IEEE).

Aside from a ranging use case, other use cases such as device free sensing, TDOA, long range ranging etc. are being actively investigated. To address the long-range ranging use case, MMS ranging is introduced in communication technique such as 802.15.4ab. The key idea behind MMS ranging is to distribute the UWB ranging frames into multiple fragments and the fragment being transmitted across multiple milliseconds, thereby overcoming the emitted energy limit of 37 nanojoules (nJ) per millisecond (ms). The MMS ranging may be further enhanced by a high-performance narrowband (NB) radio which is used to provide time synchronization for the UWB radio and is also used for control signaling. This is termed as NB-MMS ranging. In NB-MMS ranging, the number of fragments required for the ranging depends on the range to be measured as well as the channel conditions, and hence may be dynamically adjusted even within the same ranging session.

FIG. 1 illustrates an example of a communication system in which some example embodiments of the present disclosure may be implemented.

In communication system 100, a first device 110 can communicate with other multiple devices, such as a second device 120, a third device 130. The communication can carry applications such as ranging, sensing, TDOA, etc.

The block based ranging structure in communication standard such as 802.15.4z assumes a fixed block structure with round and slot duration, which is determined beforehand and largely remain unchanged during a ranging session. Hence the 802.15.4z block structure is ill suited for the NB-MMS ranging use case. To overcome such limitation, a hyper block structure has been introduced in 802.15.4ab.

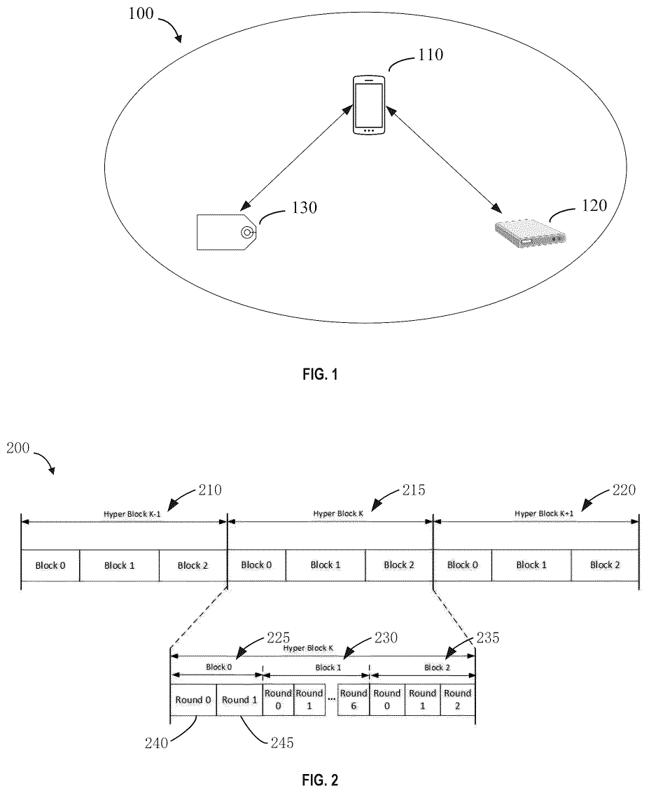

FIG. 2 illustrates an example of hyper block structure in which some example embodiments of the present disclosure may be implemented.

In some embodiments, a hyper block is a group of blocks and has a periodic time structure. In 200, there are hyper blocks 210, 215, and 220. Each hyper block consists of a whole number of blocks. Different blocks in a hyper block may have different configuration for block duration, round duration and slot duration as well as number of rounds per block and number of slots per round. The different blocks in the hyper block 215 may be used for different applications. For example, block 0 (225) is for TDOA, block 1 (230) is for ranging, and block 2 (235) is for sensing. And different blocks may comprise different number of rounds. For example, there are 2 rounds (240, 245) in block 0 (225), 7 rounds in block 1 (230), and 3 rounds in block 2 (235). Or, the blocks 225, 230, 235 may all be used for the same application, such as NB-MMS, but the different blocks are designed for different ranging usage. For example, block 1 (230) is for one-to-one ranging in good channel condition, block 0 (225) is for one-to-many ranging, and block 2 (235) is for one-to-one ranging in bad channel condition, etc.

FIG. 3 illustrates an example of round hopping in which some example embodiments of the present disclosure may be implemented.

In some embodiments, in the block-based ranging mode, a round hopping mechanism is provided in communication technique such as IEEE 802.15.4z as a strategy to help reduce interference. In 300, a controller may decide to “hop” to a different ranging round in the next ranging block. If participating enhanced ranging devices (ERDEVs) including the first device 110 and the second device 120 are using ranging round m (330) in ranging block N (315), they will use ranging round k (335) in ranging block N+1 (320), where k #m. As seen in FIG. 3, participating ERDEVs may use the 1st ranging round (325) in the ranging block N−1 (310). They may use the 2nd ranging round (330) in the ranging block N (315) and the last ranging round (335) in the ranging block N+1 (320). In the ranging round 330, there are ranging slots such as 340. By estimation of the transmission offset (350) between the first device 110 and the second device 120, ranging can be achieved. This way, interference can be avoided in the wireless communication between the first device 110 and other devices such as 120. The round hopping can also be disabled, to make the communication system design and timing simpler.

The skilled in the art can understand that the above described round hopping scheme may be generalized and used in applications other than ranging, including in applications that use the hyper block time structure, such as sensing, TDOA, etc.

It is assumed in communication system such as IEEE 802.15.4z that a round will be allocated for each device in each block. The criteria used to determine when to hop to a different relative ranging round is not defined in IEEE 802.15.4z and is assumed to be a next higher layer function or protocol. It is assumed that the devices participating in the ranging exchange have either (a) pre-negotiated a hopping sequence that is known to all devices, or (b) have exchanged all the information necessary such that each device can generate the hopping sequence so that they know which ranging round in each ranging block is to be used if hopping is triggered. As an example, for the k-th session with

$${N}_{Round}^{k}$$

rounds in the i-th block the round hopping function uses

$${N}_{Round}^{k}$$

to generate the round index for the i-th block. It can be seen that

$${N}_{Round}^{k}$$

is a constant value. Or, it is assumed that the number of rounds in a block is the same for every block.

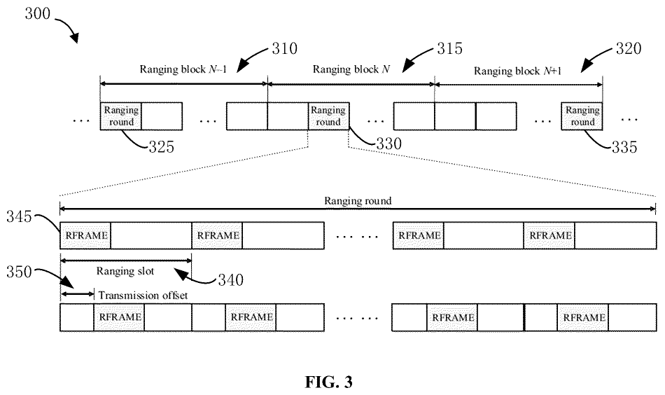

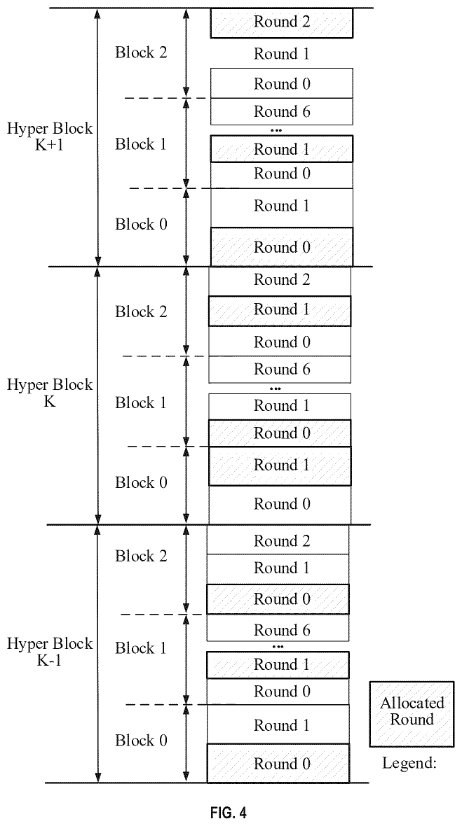

FIG. 4 illustrates an example of round selection scenario in accordance with some example embodiments of the present disclosure may be implemented.

In some embodiments, as mentioned above, it can be assumed in the communication technique such as IEEE 802.15.4z that a round will be allocated for each device in each block. If round hopping is enabled in applications that do not allocate a round for a device in every block, for example in an automotive digital key use case that uses the hyper block time structure and if a hopping sequence function is used that uses a fixed number of rounds per block, for example with

$${N}_{Round}^{k} = 3.$$

The round hopping may lead to a round selection scenario such as that shown in FIG. 4. In 400, there are hyper blocks such as 410, 415, and 420. In hyper block 410, there are 3 blocks 425, 430, and 435. One round is selected in every block and in some blocks, only a sub-set of available rounds may be selected leading to inefficient use of the block. For example, in the second block of each hyper block, even though there are 7 rounds in the block, only the first 3 rounds are selected since

$${N}_{Round}^{k} = 3$$

is used for modulus operation in the round selection functions. For example, rounds 440, 445, and 450 are selected in blocks 425, 430, and 435 respectively.

In some embodiments, as mentioned in FIGS. 2 and 3, there may be some features in a hyper block time structure. (1) The number of rounds in the current block (i) may be different from the number of rounds in the next block (i+1). (2) The slot duration, and/or the number of slots per round in the current block (i) may be different from the slot duration and/or the number of slots per round in the next block (i+1). For NB-MMS, this may be simplified as the round duration. (3) The allowed application in the current block (i) may be different from the allowed application in the next block (i+1).

This may lead to the scenario that if any of the hopping sequence function is used in applications that do not allocate a round for the second device 120 in every block, for example in applications that uses the hyper block time structure, the round selected by the round hopping scheme in a block may not be suitable for the second device 120. For example, none of the rounds in block 1 in FIG. 4 may be suitable for the second device 120 due to insufficient round duration, or block 2 may be reserved for a different application. This may lead to the controller, or the first device 110 not allocating a round for the device in the block. This can be true for any applications that do not allocate a round for a device in every block, regardless of whether round hopping is used or not. However, the second device 120 may not be aware that it is not allocated a round in some blocks and will still check every block to see whether it is allocated a round in the block, leading to power wastage for the second device 120. In addition, if a small value is chosen for the number of rounds per block, such as 3, only a subset of rounds may be selected in some block with more than 3 rounds. This leads to resource waste in the short blocks.

The present disclosure is applicable in any communication technique such as UWB application that uses the block-based time structure that may not allocate a round for a device in every block, for example in an application that uses the hyper block time structure.

The following terms are used in the present disclosure.

Controller: a device such as the first device 110 that controls a communication session such as UWB session and defines session parameters.

Controlee: a device such as the second device 120 that utilizes the session parameters received from the controller to participate in the communication session such as UWB session.

Initiator: a device that following the instruction from the controller, initiates a communication exchange such as UWB exchange by sending the first message of the exchange. A controller or a controlee can be an initiator.

Responder: a device that responds to the first message received from the initiator and participates in the communication exchange such as UWB exchange.

Network: a set of two or more devices, such as device 120 and 130 in FIG. 1 that participate in the communication session such as the UWB session.

Assigned block: for a device or network, an assigned block is a block in which the device or its network is allocated at least one round for transmission or reception.

Hyper block advertisement round: a round that occurs at least once in each hyper block and is used to advertise the assigned block or blocks for the device or set of devices forming network in that hyper block.

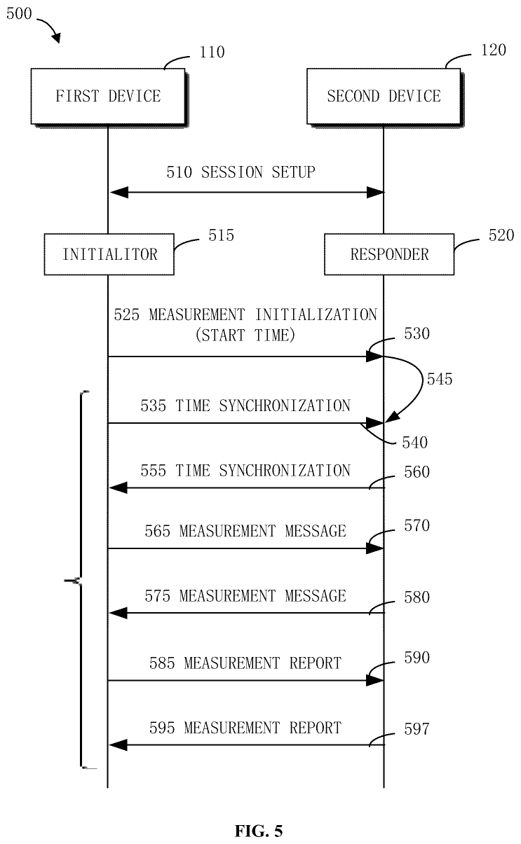

FIG. 5 illustrates a message flow in a UWB session in accordance with some example embodiments of the present disclosure.

In some embodiments, the UWB session 500 begins with the first device 110 such as a controller and the second device 220 such as controlee performing a session setup 510. During the session setup 510, long-term session parameters such as a UWB channel number, preamble codes, a block structure, etc. are negotiated. The block structure includes number of blocks, and block duration. For NB-MMS ranging, parameters related to narrow band, such as NB channel number, the default number of MMS fragments etc., may also be negotiated during the session setup 510. Additionally, the initiator 515 and responder 520 roles are assigned during the session setup. FIG. 5 illustrates the controller assuming the role of initiator while the controlee is assigned the role of responder, however it is also possible that the controlee may be assigned the role of initiator while the controller assumes the role of responder. It is also possible that during the session setup 510, different controlees can take roles of initiator and responder respectively. The long-term parameters are not expected to change during the session 500. In contrast, parameters related to a measurement cycle such as round or slot durations, number of MMS fragments, report mode etc. may be considered short term parameters and may be modified during the session 500. The session setup 510 may be performed out-of-band, for example using Bluetooth or Wi-Fi radio, or may also be performed in-band, for example using narrow band or UWB radio.

When the actual UWB measurement such as ranging or sensing is to be performed, the initiator 515 sends (530) a measurement initialization message 525 to the responder 520 informing the start time at which the measurement cycle is to start. For the NB-MMS case, the start of ranging (SOR) message may be used as the measurement initialization message 525. At the indicated start time 545, the initiator 515 and the responder 520 exchange (540, 560) time synchronization messages, such as POLL or response (RESP) messages to synchronize their clocks with each other. The exchange of time synchronization messages 535, 555 is followed by an exchange (570, 580) of measurement messages 565, 575. For example, for ranging, this may be ranging packets or frames (RFRAME). Or if using NB-MMS, this may be ranging sequence fragments (RSFs) and ranging integrity fragments (RIFs). Finally, the measurement cycle is concluded by exchange (590, 597) of measurement reports 585, 595, such as RPRT messages. When block-based time structure is used, one measurement cycle is completed within one round, such as within the ranging round 330 in FIG. 3.

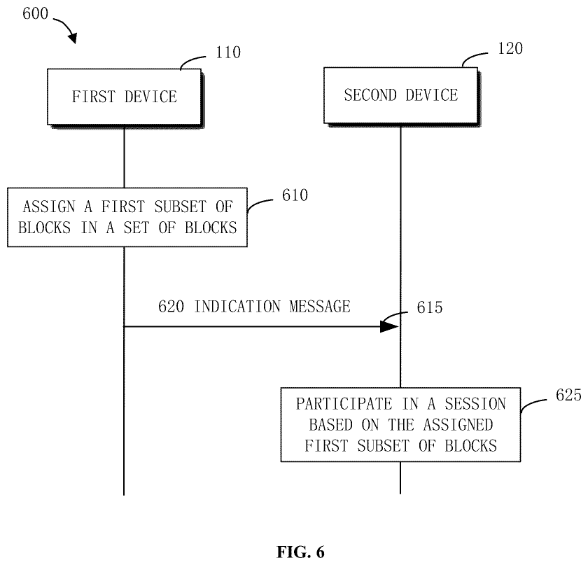

FIG. 6 illustrates an example of a process flow with block assignment in accordance with some example embodiments of the present disclosure.

In the process flow 600, the first device 110 assigns (610) a first subset of blocks in a set of blocks of a block-based time structure to the second device 120 or a set of devices including the second device 120. The first device 110 transmits (615) to the second device 120, an indication message 620 indicating that the subset of blocks is assigned to the second device 120 or the set of devices. After receiving (615) the indication message 620, the second device 120 participates (625) in a session based on the assigned first subset of blocks. This way, the second device 120 can get indication of which blocks are allocated to it, and avoids listening to all the blocks, and avoids power waste. To participate (625) in a session in the assigned block, the devices may also be required to calculate the index of the allocated round in the block, for example when round hopping is enabled in the block.

In some embodiments, a position of the first round in a first block in the first subset of blocks is same or different from a position of the second round in a second block in the first or next subset of blocks, and the first round and the second round are allocated to the second device 120. The position can be indicated by round index. In details, in some embodiments, the indication message can be transmitted in the set of blocks, to indicate the first subset of blocks in the set of blocks. The second subset of blocks is in the next set of blocks. The position of the first round in a first block in the first subset of blocks is same or different from the position of the second round in a second block in the first or next subset of blocks. In some other embodiments, the indication message can be transmitted in a previous set of blocks, to indicate the first subset of blocks in the set of blocks. The second subset of blocks is in the next set of blocks. The position of the first round in a first block in the first subset of blocks is same or different from the position of the second round in a second block in the first or next subset of blocks.

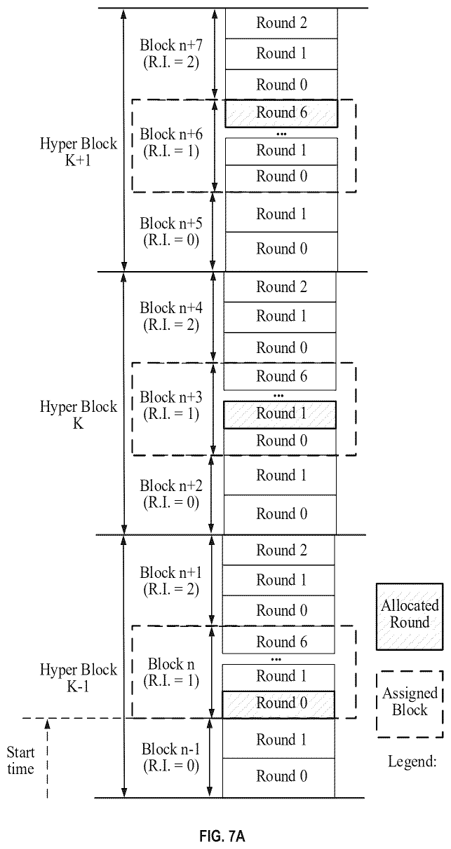

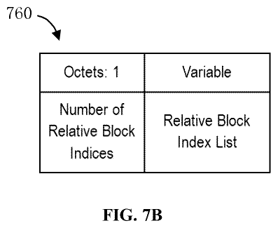

FIG. 7A illustrates an example of same block assignment in hyper blocks in accordance with some example embodiments of the present disclosure.

In 700, blocks in hyper block K−1 (710) are set of blocks, block n (725) is the first subset of block. Blocks in hyper block K (715) are next set of blocks, block n+3 (735) is the second subset of block. Start time in the measurement initialization message 525 in FIG. 5 indicates block n (725) in hyper block K−1 (710). The position of round 0 (730) in block n (725) is different with the position of round 1 (740) in block n+3 (735).

In some embodiments, in order to avoid any ambiguity for devices, in a session, the second device 120 or set of devices including the second device 120, such as to form a network is always allocated a round in the same subset of blocks within a set of blocks in a hyper block. In some embodiments, the subset of blocks can include one block. For the second device 120 or set of devices, a block in which the second device 120 or the set of devices is allocated at least one round for transmission or reception is known as an assigned block. The first device 110 such as the controller may assign the subset of blocks to devices or network based on factors, such as but not limited to the required slot numbers or durations, or application type such as TDOA, ranging, or sensing. The factors can also include measurement frequency requirements, such as how often measurements need to performed, etc. Such a block assignment is illustrated in FIG. 7A. The second block in the set of blocks in every hyper block is assigned to devices including the first device 110 such as the initiator and the second device 120 such as the responder, participating in one-to-one ranging. In block assignment 700, the position of the blocks 725, 735, 745 are the same in hyper blocks 710, 715, and 720 respectively. The fixed block assignment can make the communication easier and efficient. The position of the rounds 730, 740, and 750 are different in the blocks 725, 735, 745, to avoid interference with round hopping. The skilled in the art can understand that the round hopping can also be disabled.

In some embodiments, it is assumed that the hyper block structure already exists prior to the devices joining the session, for example when the second device 120 such as the responder joins an existing ranging network (RAN). Otherwise, the block and hyper block indices will start from 0 in the hyper block referred by the start time in the measurement initialization message 525 in FIG. 5.

In some embodiments, either implicit or explicit signaling may be used to communicate the assigned block to devices. When implicit signaling is used, the 802.154ab specification mandates that the block in which a device is initially assigned a slot is its assigned block in future hyper blocks as well. For example, in the first round indicated by the start time in the measurement initialization message 525, the first device 110 such as the controller may transmit a ranging device management information element (RDM IE) defined in IEEE 802.15.4z to allocate at least one slot to the second device 120 in a round. The block in which the first allocated round is located is considered the assigned block, such as block n (725) in FIG. 7A. Henceforth it is assumed that the second device 120 will be allocated a round in the block at the same relative position in the subsequent hyper blocks 715 and 720. Alternatively, explicit signaling may be used in which the first device 110 such as the controller informs the set of devices the relative index (R.I.) of their assigned block or blocks within the hyper block, for example during the session setup 510. Devices save the relative index (R.I.) of the assigned block or blocks within the hyper block, such as R.I.=1 in FIG. 7A. The R.I. of the assigned block or blocks within the hyper block is maintained as a long-term operating parameter. Or, the block assignment remains the same for the entire session or until updated by the controller. The block assignment IE (BA IE) illustrated in FIG. 7B may be used for the explicit signaling.

In some embodiments, in the BA IE 760, the Number of Relative Block Indices field indicates the number of relative block indices present in the Relative Block Index List. The Relative Block Index List contains one or more relative block index of the at least one block assigned to the second device 120. Upon receiving the block structure, either during session setup 510, or in the first assigned block, devices also save the number of rounds in the block or blocks

$${N}_{i , Round}^{k}$$

for use in the round hopping function. This way, the first device 110 can informs the second device 120 or set of devices about the block assignment efficiently.

Since the number of rounds in the blocks of a hyper block may be different, the function used to generate the hopping sequence need to factor in the fact that the number of rounds in different blocks may be different. As an example, for the k-th session with

$${N}_{i , Round}^{k}$$

rounds in the i-th block the round hopping function uses

$${N}_{i , Round}^{k}$$

to generate the round index for the i-th block.

Compared to the previous implementation, the key difference in the above functions is that

$${N}_{i , Round}^{k}$$

is used mislead of

$${N}_{Round}^{k} .$$

### Since

$${N}_{i , Round}^{k}$$

reflects the actual number of rounds in the i-th block, the round selected by either of the two hopping sequence functions will not be limited to a sub-set of the available rounds. Referring to FIG. 7A, assuming round hopping is enabled in both the first device 110 such as initiator and the second device 120 such as responders, the hopping sequence function leads to the selection of round 0 (730) in the 2nd block (725) in hyper block K−1 (710), round 1 (740) in the 2nd block (735) in hyper block K (715) and round 6 (750) in the 2nd block (745) in hyper block K+1 (720).

Alternatively, original hopping sequence functions may be used with

$${N}_{Round}^{k} = {max}_{i = 1 to M} ( {N}_{i , Round}^{k} ) .$$

Here, M is the number of blocks in a hyper block, for example, M=3 in FIG. 7A and using the above expression,

$${N}_{Round}^{k}$$

will be equal to 7, the maximum number of rounds in a block, such as the number of rounds in the second block.

Since the assigned subset of blocks or assigned block within the set of blocks in hyper block is known to devices including initiator and responder in advance, they only need to participate in the allocated round in the assigned block. Devices can also correctly determine the allocated round in the assigned block when round hopping is used. Further, a device can skip the unassigned blocks, or it need not participate in blocks in which it is not allocated any round, and thus save power. Referring to FIG. 7A, devices only participate in the 2nd block of each hyper block and can skip the 1st and 3rd blocks of each hyper block.

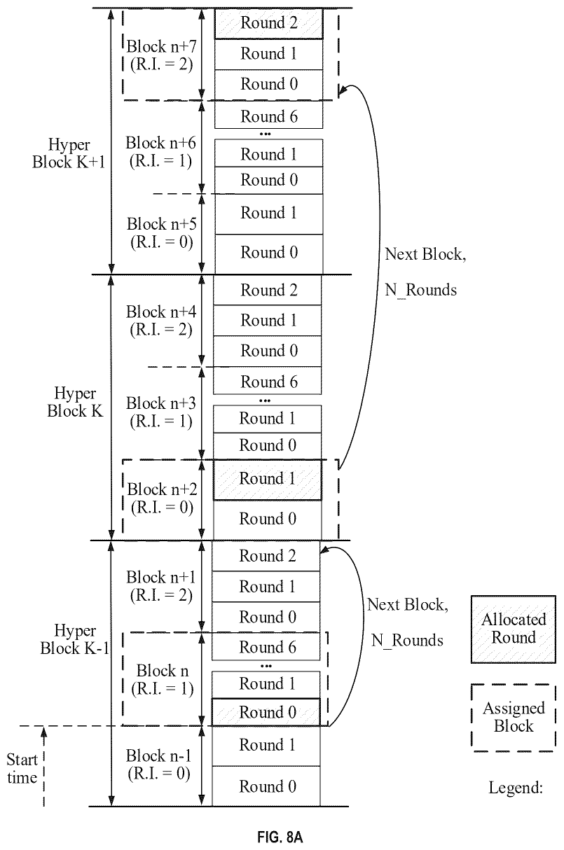

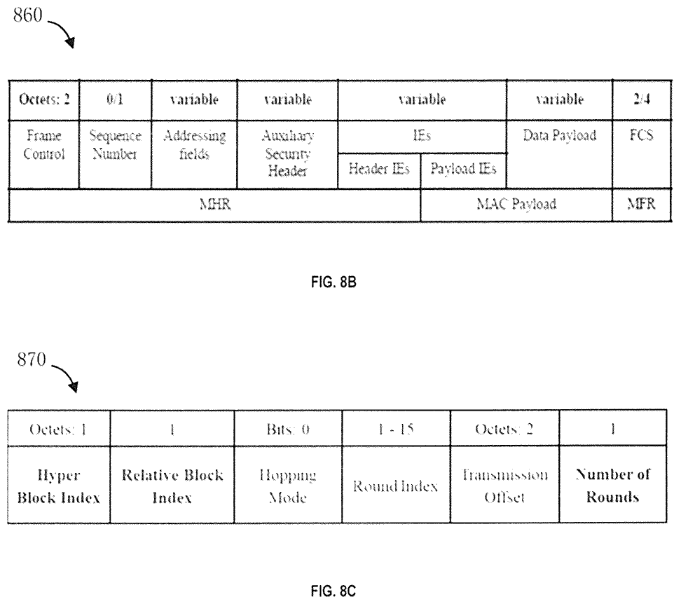

FIG. 8A illustrates an example of dynamic block assignment in accordance with some example embodiments of the present disclosure.

In 800, blocks in hyper block K (815) are set of blocks, block n+2 (835) is the first subset of block. Blocks in hyper block K+1 (820) are next set of blocks, block n+7 (845) is the second subset of block. Indication message transmitted in block n (825) indicates block n+2 (835). The position of round 1 (840) in block n+2 (835) is different from the position of round 2 (850) in block n+7 (845).

The mechanism described in embodiment with fixed block assignment is effective in resolving the problems of power waste in the second device 120. However, embodiment with fixed block assignment suffers from a rigid structure in which the same subset of blocks is assigned to set of devices or the second device 120 in every hyper block and the first device 110 such as the controller is not able to assign blocks to devices dynamically based on situation, such as changes in the MMS fragments due to changes in channel conditions etc. This drawback in fixed block assignment may be overcome if in the first and each subsequent allocated round, the first device 110 such as the controller informs the next assigned block and the number of rounds in the assigned block to the set of devices or the second device 120. The controller may dynamically assign any block in a hyper block to the second device 120 or set of devices based on factors, such as but not limited to changes in the required slot numbers or durations. For example, due to changes in the number of MMS fragments, or changes in the measurement frequency requirements, etc. This is illustrated in FIG. 8A.

The block in which the first allocated round, such as the round indicated by the start time in the message initialization message 525 is located is considered the first assigned block, or round 0 (830) in block n (825). Among other communications, in round 0 (830), the first device 110 such as the controller sends an indication message informing all participating devices in round 0 that the next assigned block for the devices is block n+2 (835), or the 1st block in hyper block K (815), and the number of rounds in block n+2 is 2. Assuming round hopping is enabled in the devices, the hopping sequence function leads to the selection of round 1 (840) in block n+2 (835) and the devices will be ready for communication at the start of round 1 (840) in block n+2 (825). Similarly, in this round, the first device 110 such as the controller sends an indication message informing all participating devices that the next assigned block for the devices is block n+7 (845), or the 3rd block in hyper block K+1 (820), and the number of rounds in block n+7 (845) is 3. Since round hopping is enabled in the devices, the hopping sequence function leads to the selection of round 2 (850) in block n+7 (845).

Since the next assigned block within the hyper block is known to devices including the initiator and the responder in advance, they only need to participate in the allocated round in the assigned blocks. Devices can also correctly determine the allocated round in the assigned block when round hopping is used. Further, a device can skip the unassigned blocks, or it need not participate in blocks in which it is not allocated any round, and thus save power. Referring to FIG. 8A, devices only participate in one of the blocks of each hyper block and can skip the other two blocks of each hyper block. This way, the indication message can be transmitted in the current block, to indicate the block assignment in the next, the block assignment is dynamic and flexible for application allocation and can match dynamic channel condition.

While the described mechanism allows the first device 110 such as the controller to assign blocks very flexibly, even allowing entire hyper blocks to be skipped, it may be prudent to have rules in the 802.15.4ab specification such that the controller assigns at least one block in every hyper block to devices.

FIG. 8B illustrates an example of a data frame in accordance with some example embodiments of the present disclosure.

In some embodiments, the controller may transmit an enhanced ranging round information element (ERR IE) to inform the next assigned block and the number of rounds in the block to devices. ERR IE can be a Nested IE within the payload IE in a ranging control message (RCM) which is a data frame as illustrated in FIG. 8B. The indication message such as ERR IE is illustrated in FIG. 8C. Since the blocks in a hyper block may be of different duration, calculating the start time of the next assigned block based on the hyper block index and relative block index is more efficient, compared to calculating the start time based on the absolute index of the blocks.

In some embodiments, in ERR IE 870, the hyper block index field specifies the index of the hyper block in which the next assigned block is located. The relative block index field specifies the relative index of the next assigned block in the hyper block, in which the first block is indicated by the relative index 0. The hopping mode field specifies the hop mode for the next assigned block, where zero means no hopping and one means hopping. The round index field specifies the round index for the next assigned ranging block when round hopping is not enabled. The transmission offset field specifies the value of transmission offset of the round in the next assigned block, in RSTU. The number of rounds field specifies the number of rounds in the next assigned block and is present when the hopping mode field indicates hopping, such as set to one. This way, the ERR IE is transmitted to indicate the detailed block and round allocation in the next hyper block clearly.

Upon receiving the ERR IE, if the hopping mode field indicates that round hopping is enabled, the second device 120 or set of devices use the hopping sequence function together with the number of rounds to calculate the allocated round in the next assigned block. A device can also calculate the absolute Block Index (B_I) as:

$$B\_I = H\_B \_I * N\_Blocks + R\_B \_I$$

Here, H_B_I is the index of the current hyper block, N_Blocks is the number of blocks in a hyper block and R_B_I is the value indicated in the relative block index field. It is assumed that the hyper block indices start from 0. If the block indices start from 1:

$$B\_I = ( H\_B \_I - 1 ) * N\_Blocks + R\_B \_I$$

The absolute block index (B_I) may be used, for example to calculate the NB channel used in a block when channel hopping is enabled for NB. In the event that second device 120 or set of devices are assumed to be aware of the hyper block structure and the number of rounds in each block of the hyper block, even if the number of rounds in the assigned block is not provided, such as by setting the number of rounds field to zero. Based on the relative block index field, devices will still be able to correctly calculate the allocated round in the assigned block when hopping is enabled. The ERR IE may be included in any message sent by the initiator 515 to the responder 520 in the current round, for example in the RCM or in the measurement report 590.

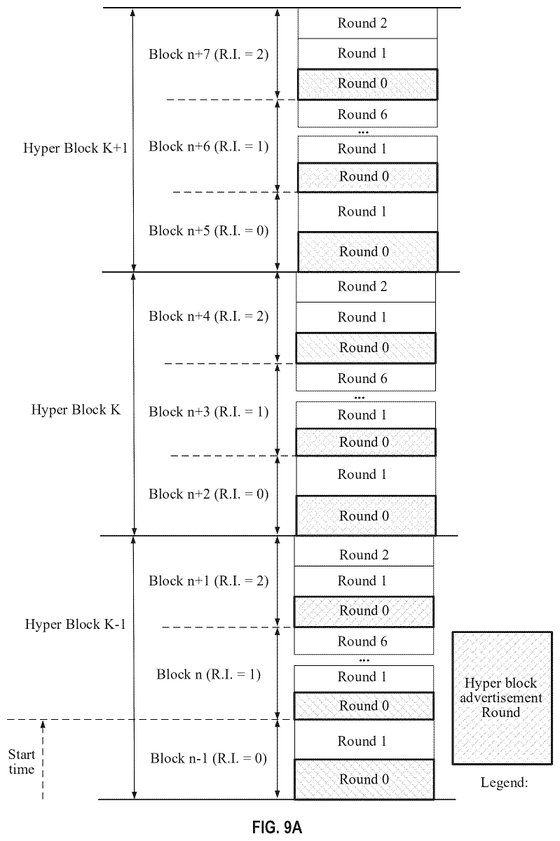

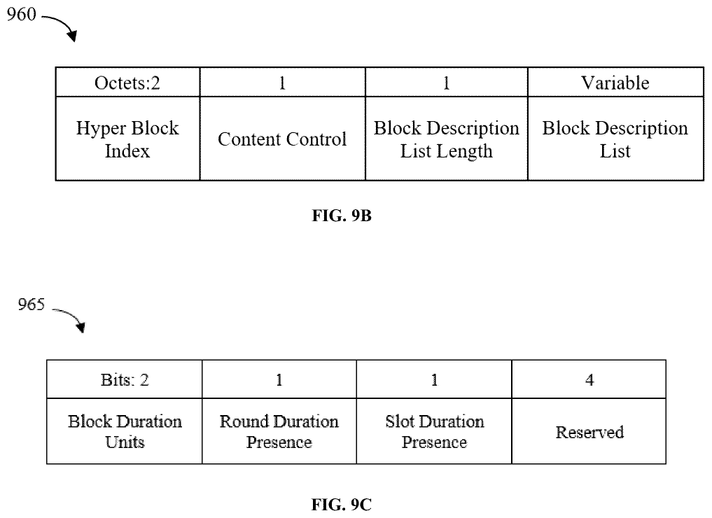

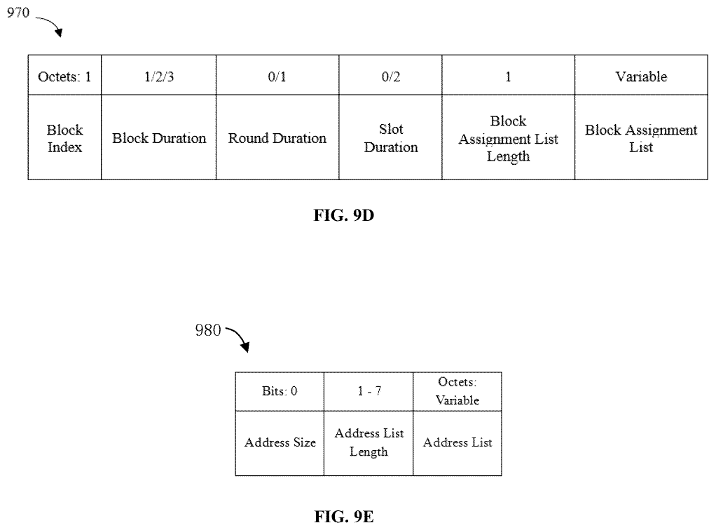

FIG. 9A illustrates an example of the hyper block advertisement round in accordance with some example embodiments of the present disclosure.

In the event that the second device 120 fails to receive the message from the first device 110 such as the controller informing the next assigned block with the ERR IE. For example, due to an interference event, the second device 120 will not be aware of its next assigned block. To help devices such as the second device 120 to recover from such situations, the first device 110 such as the controller can mandate a receiving device to transmit a frame such as an acknowledgement (ACK) frame, acknowledging the reception of the indication message such as the ERR IE, informing the next assigned block. If the controller does not receive the acknowledgement, the controller can transmit the message informing the next assigned block in every subsequent block such as in the first round, until the message is acknowledged by the device. However, this method may not be very efficient. An alternative mechanism is proposed to overcome this inefficiency: the controller allocates a hyper block advertisement (HBA) round at least once in each hyper block to advertise the assigned block for each participating device or set of devices, such as devices in ranging area network. The round may be fixed as the first round of the first block in each hyper block, or it may be a negotiated round in a certain block of each hyper block. The negotiation can be in the session setup 510, and may be indicated, for example, using an HBA Relative Round Index field and a Relative Block Index field in the BA IE in FIG. 7B that specify the relative index of the HBA round and the Block in which the HBA round is located within a hyper block. In each hyper block advertisement round in rounds 930, 940, and 950, the first device 110 such as the controller transmits a broadcast message advertising the subset of blocks assignments for the set of devices participating in that hyper block, as well as the number of rounds in each block in the hyper block. This is illustrated in FIG. 9A, in which the first round in the first block of each hyper block is fixed as the Hyper block advertisement round. Any device that failed to receive the message informing the next assigned block may wait for the broadcast message to figure out its next assigned block. This way, the indication information for block allocation can be transmitted reliably.

FIG. 9B illustrates an example of the hyper block structure information element in accordance with some example embodiments of the present disclosure.

The hyper block structure information element (HBS IE) 960 is used, for example in RCM, to advertise the block assignment for the device 120 or set of devices participating in that hyper block. The Hyper Block Index field specifies the index of the hyper block.

The Content Control field 965 in FIG. 9C indicates the units of the Block Duration field as well as presence or absence of the Round Duration field and the Slot Duration field in the Block Description field. The Block Duration Units field indicates the size and the unit used for the Block Duration field as listed in the following table.

| Block Duration | |
|---|---|
| Units field value | Description |
| 00 | Size of Block Duration field is 1 octet and |
| | the unit of Block Duration field is the |
| | number of rounds |
| 01 | Size of Block Duration field is 2 octets and |
| | the unit of Block Duration field is the |
| | number of slots |
| 10 | Size of Block Duration field is 3 octets and |
| | the unit of Block Duration field is RSTU |
| 11 | Reserved |

The Round Duration Presence bit indicate whether the Round Duration field is present, zero indicating absence and one indicating presence.

The Slot Duration Presence bit indicate whether the Slot Duration field is present, zero indicating absence and one indicating presence.

The block description list length specifies the number of block descriptions in the block description list field. The block description list carries a list of block description fields illustration in FIG. 9D. Each block description field carries information of one block of the hyper block. The position of the block description field in the block description list determines the position of the corresponding block within the hyper block. This way, the HBS IE can be broadcast to all the devices reliably, to avoid communication interruption due to such as interference or channel change.

FIG. 9D illustrates an example of block description in accordance with some example embodiments of the present disclosure.

In the block description 970, the Block Index field specifies the index of the current block within the hyper block. The Block Duration field specify the duration of the block in units specified by the Block Duration Units field. The Round Duration field specifies the duration of the round in units of slots, i.e., the number of slots in the round. The Slot Duration field specifies the duration of a slot in units of RSTU. The number of rounds in the block can be calculated as

$$\frac{block duration}{round duration} .$$

The block assignment list length field specify the number of block assignment fields in the block assignment list field. The block assignment list carries a list of block assignments (zero or more) illustrated in FIG. 9E. Each block assignment carries a list of addresses of network or devices that are allocated a round in the block. This way, the detailed parameters for the assigned blocks can be transmitted reliably to the set of devices, to avoid communication interruption due to such as interference or channel change.

FIG. 9E illustrates an example of block assignment in accordance with some example embodiments of the present disclosure.

The address size field specifies the size used for addresses in the Address List, 0 for short address (such as 2 octets), and 1 for extended address (such as 8 octets). The address list length field specifies the number of addresses in the address list. The address list field carries a list of address of the second device 120 or set of devices that are allocated one or more round in the block. For set of devices or networks, short address is used.

Upon receiving the HBS IE in the hyper block advertisement round, if the second device 120 finds its device address or the address of the network it belongs to in the HBS IE, it will know the block that is assigned to it as well as the number of rounds in the block. Based on this information, the second device 120 can also calculate its allocated round in the block if round hopping is enabled.

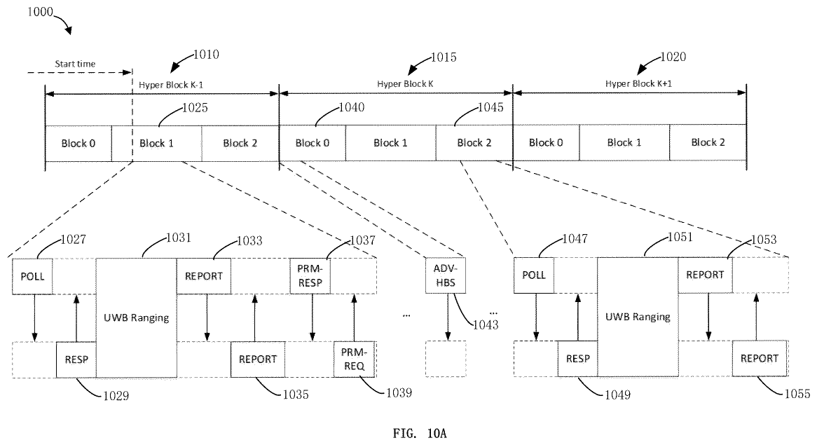

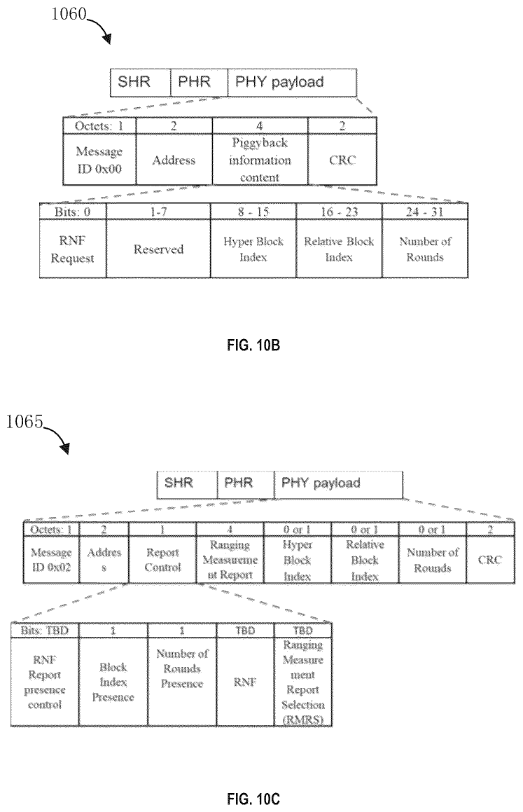

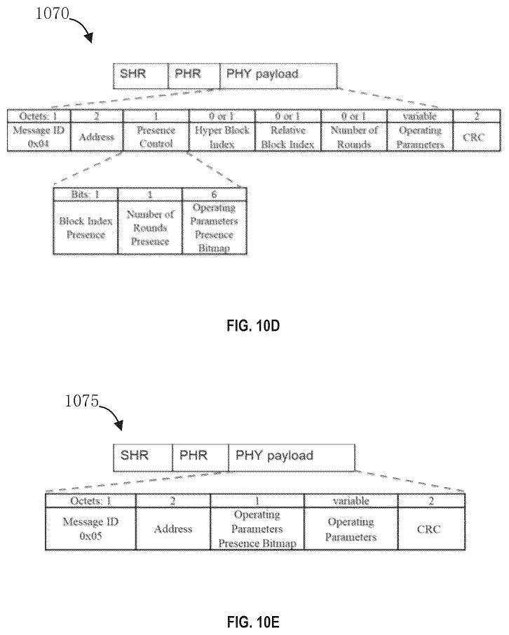

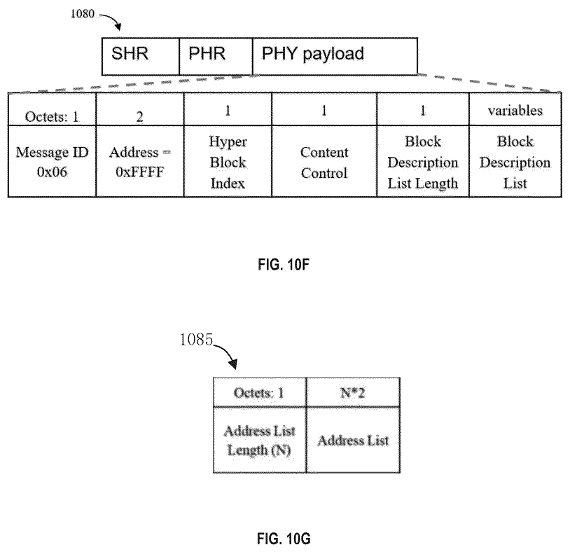

FIG. 10A illustrates an example of signaling in MMS ranging in accordance with some example embodiments of the present disclosure.

Embodiment in FIG. 10A inherits the same dynamic block assignment mechanism in the embodiment in FIG. 8A as well as the block assignment advertisement mechanism in the embodiment in FIG. 9A. In some embodiments, FIG. 10A is catered for MMS ranging applications that use the hyper block time structure. The control frames for the MMS can be transmitted using UWB or NB. The overall signaling is illustrated in FIG. 10A. After completing the session setup 510, either over out of band (OOB) or NB, the first device 110 such as the controller informs the start time (or time offset) to the devices involved in the MMS ranging, for example, in the second round in the second block 1025 of the hyper block K−1 (1010). The initiator initiates the MMS ranging measurement cycle by transmitting a POLL message 1027 at the indicated start time and the responder responds with the RESP message 1029. The primary purpose of the POLL message 1027 and the RESP message 1029 exchange is to achieve time synchronization between the initiator and the responder. The devices then proceed to exchange UWB ranging packets followed by exchange of RPRT messages 1033, 1035, carrying the ranging reports. The RPRT messages 1033, 1035 are optionally followed by a PRM-RESP message 1037 from the initiator to update any short-term operating parameters, and a PRM-REQ message 1039 from the responder to request any short-term operating parameters.

The initiator may also include information of the next assigned block and the number of rounds in the block in any of the messages transmitted by it, such as POLL, RPRT or PRM-RESP. In rounds that are designated as a hyper block advertisement round, such as the first round in the first block of every hyper block, the Initiator may also transmit an ADV-HBS message to advertise the block assignment for the set of devices or device network participating in that hyper block. Any device that failed to receive the message informing the next assigned block may wait for the ADV-HBS message to figure out its next assigned block. The various types of NB-MMS messages that may be used to carry the assigned block information are listed in the following table.

| Frame Length | | | |
|---|---|---|---|
| (octet) | Message ID | Data Content Description | Remark |
| 5 | 0 × 00 (POLL) | Poll | |
| 6 | | Poll with 1-octet piggybacking | |
| | | information | |
| 7 | | Poll with 2-octet piggybacking | |
| | | information | |
| 9 | | Poll with 4-octet piggybacking | To assign the next |
| | | information | block |
| variable | 0 × 04 | Message used by Initiator to | |
| | (PRM-RESP) | update short -term operating | |
| | | parameters | |
| variable | 0 × 05 | Message used by Responder to | |
| | (PRM-REQ) | request short -term operating | |
| | | parameters | |
| variable | 0 × 06 | Message used by Initiator to | |
| | (ADV-HBS) | advertise hyper block related | |
| | | information | |

The Initiator may use the 9 octets long POLL message to inform the responder its next assigned block. The format of the 9 Octets POLL message is illustrated in FIG. 10B. In the POLL message 1060, the information related to the next assigned block is carried in the piggyback information content field. The hyper block index field specifies the index of the hyper block in which the next assigned block is located. The relative block index field specifies the relative index of the next assigned block in the hyper block, where the first block=0. The number of rounds field specifies number of rounds in the block indicated by the relative block index field.

FIG. 10C illustrates an example of RPRT message in accordance with some example embodiments of the present disclosure. In details, the format of the RPRT message when used to carry the information related to the next assigned block is illustrated in FIG. 10C.

In some embodiments, in the RPRT message 1065, the block index presence bit in the report control field indicates whether the hyper block index field and the relative block index fields are present in the RPRT message, wherein zero indicating absence and one indicating presence. The number of rounds presence bit indicate whether the number of rounds field is present in the RPRT message, wherein zero indicating absence and one indicating presence. The hyper block index field specifies the index of the hyper block in which the next assigned block is located. The relative block index field specifies the relative index of the next assigned block in the hyper block, wherein the first block=0. The number of rounds field specifies number of rounds in the block indicated by the relative block index field. This way, the ranging report can be transmitted in detailed information.

FIG. 10D illustrates an example of PRM-RESP message in accordance with some example embodiments of the present disclosure. In details, the format of the PRM-RESP message when used to carry the information related to the next assigned block is illustrated in FIG. 10D.

In some embodiments, the presence control field carries bits to indicate presence or absence of various fields. The block index presence bit indicates whether the hyper block index field and the relative block index fields are present in the PRM-RESP message, wherein zero indicating absence and one indicating presence. The number of rounds presence bit indicate whether the number of rounds field is present in the PRM-RESP message, wherein zero indicating absence and one indicating presence. The operating parameters presence bitmap carries bits to indicate presence or absence of various operating parameters related to the session. The hyper block index field specifies the index of the hyper block in which the next assigned block is located. The relative block index field specifies the relative index of the next assigned block in the hyper block, wherein the first block=0. The number of rounds field specifies number of rounds in the block indicated by the relative block index field. The operating parameters field carries various operating parameters related to the session. This way, the operation parameters for short term can be updated, to match the changing channel condition in the session.

FIG. 10E illustrates an example of PRM-REQ message in accordance with some example embodiments of the present disclosure. In details, the Responder may use the PRM-REQ message to request short-term operating parameters for the next ranging-measurement cycle. The format of the PRM-REQ message is illustrated in FIG. 10E.

The operating parameters presence bitmap carries bits to indicate presence or absence of various operating parameters related to the session. The operating parameters field carries various operating parameters related to the session that the responder is requesting from the Initiator for the next measurement cycle. Although not shown in any of the FIG. 16, FIGS. 10D, 10E, and 10F. The POLL, RPRT or the PRM-RESP messages may also include the hopping mode bit, the round index field and the timing offset field illustrated in FIG. 8C, or ERR IE with the same meaning. This way, the operation parameters for short term can be updated, to match the changing channel condition in the session.

FIG. 10F illustrates an example of ADV-HBS message in accordance with some example embodiments of the present disclosure. In details, the ADV-HBS message illustrated in FIG. 10F is used to advertise hyper block related information, such as block durations, the block(s) assignment for the set of devices or device network participating in that hyper block.

In some embodiment, the address field is set to the broadcast address, which can be 0xFFFF. The broadcast address can also be any other value. The Hyper Block Index field indicates the index of the current hyper block. The Content Control field which is the same with 965 illustrated in FIG. 9C indicates the units of the Block Duration field as well as presence or absence of the Round Duration field and the Slot Duration field in the Block Description field. The block Description List Length specifies the number of block descriptions in the Block Description List field.

In some embodiments, the block description list carries a list of Block Description fields illustrated in FIG. 9D. Each Block Description field carrying information of one block of the hyper block. The position of the Block Description field in the Block Description List field determines the position of the corresponding block within the hyper block. The format and content of the block description field is the same as described in the embodiment of FIG. 8A, except that the block assignment list carries a list of block assignments with zero or more, which is illustrated in FIG. 10G. Each block assignment carries a list of short addresses of network or devices that are allocated a round in the block. This way, the hyper block related information can be broadcast to the set of devices, to avoid communication interruption. If a device finds its own address or the address of the network that it belongs to in the Address List field of the Block Assignment 1085, it can determine that the block indicated by the Block Description field is the block assigned to it.

FIG. 10G illustrates an example of block assignment list in accordance with some example embodiments of the present disclosure.

In some embodiments, in the block assignment list 1085, the address list length field specifies the number of short addresses in the address list. The address list field carries a list of short address of the network or devices that are allocated one or more round in the block. For networks, short address is used. This way, the detailed block assignment information can be broadcast reliably, to avoid interruption.

Upon receiving the ADV-HBS message in the Hyper block advertisement round, if a device finds its device address or the address of the network it belongs to in a Block Assignment field, it will know the index of the block that is assigned to it as well as the number of rounds in the block. Based on this information, the device can also calculate its allocated round in the block if round hopping is enabled.

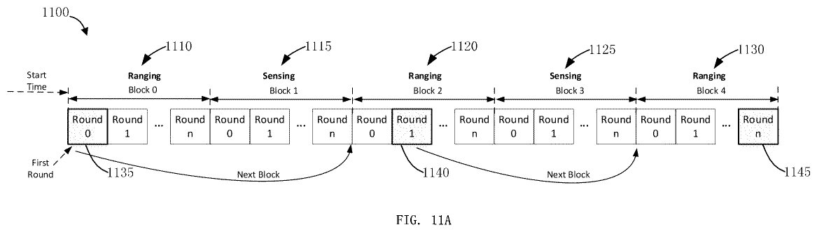

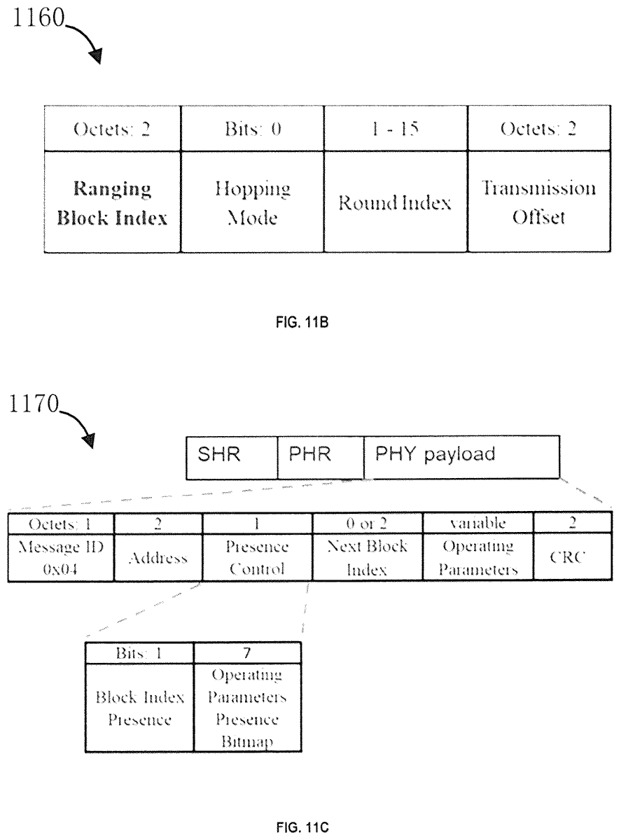

FIG. 11A illustrates an example of blocks assignment for several applications in accordance with some example embodiments of the present disclosure.

In 1100, two adjoining blocks form a set of blocks, for example, block 2 (1120) and block 3 (1125) are set of blocks, block 2 (1120) is the first subset of block. Blocks 4 (1130) and the block next to it are next set of blocks, block 4 (1130) is the second subset of block. Indication message transmitted in block 0 (1110) indicates block 2 (1120). The position of round 1 (1140) in block 2 (1120) is different from the position of round n (1145) in block 4 (1130).

In some embodiments illustrated in FIGS. 7A, 8A, 9A and 10A, it was assumed that the hyper block time structure was used when the controller wants to use the block-based time structure for different applications. However, it is also possible that in simple cases where the number of applications is not big, the controller may choose to use the simpler fixed block-based time structure defined in IEEE 802.15.z. One example scenario is illustrated in FIG. 11A, in which the controller reserves alternate blocks for two different applications, such as ranging and sensing.

Referring to FIG. 11A, upon completing the session setup with ranging devices, the controller informs them the start time of the first allocated round, for example, round 0 (1135) in the first block reserved for ranging, or block 0 (1110). In the first and each subsequent allocated round, the controller informs the next assigned block to the devices, for example in block 0 (1110), the next assigned block is block 2 (1120), with round 1 (1140), and the next assigned block is block 4 (1130), with round n (1145). Block 1 (1115) and block 3 (1125) are assigned to sensing.

The skilled in the art can understand that the blocks can also be not allocated alternatively for different applications, but in any sequence. For example, ranging is assigned to block 0, 1, 3, and sensing is assigned to block 2, 4.

FIG. 11B illustrates an example of RR information element in accordance with some example embodiments of the present disclosure.

When the legacy 802.15.4 frame format is used, the RR IE defined in IEEE 802.15.4z and illustrated in FIG. 11B may be used by the controller to indicate the next assigned block. The RR IE 1160 may be included either as the second RR IE in the RCM, or in the last scheduled downlink (DL) message from the controller in the current round. In IEEE 802.15.4z, the ranging block index field can only indicate the index of either the current or the next block, but when used to indicate the next assigned block as described here, it may be set to the index of any future block. Meaning of the rest of the fields are same as in IEEE 802.15.4z and all refer to the next assigned block indicated by the Ranging Block Index. Upon receiving the RR IE 1160, the second device 120 can calculate its allocated round in the next assigned block if round hopping is enabled.

FIG. 11C illustrates an example of PRM-RESP message for MMS ranging control signaling in accordance with some example embodiments of the present disclosure.

Any of the POLL, RPRT or PRM-RESP messages described in the embodiment in FIG. 10A may be used by the controller to inform the next assigned block. As an example, the PRM-RESP message when used for this purpose is illustrated in FIG. 11C.

In some embodiments, the block index presence bit in the presence control field indicates whether the next block index field is carried in the message. The next block index field specifies the index of the next assigned block. This way, the blocks can be assigned simply with several different applications.

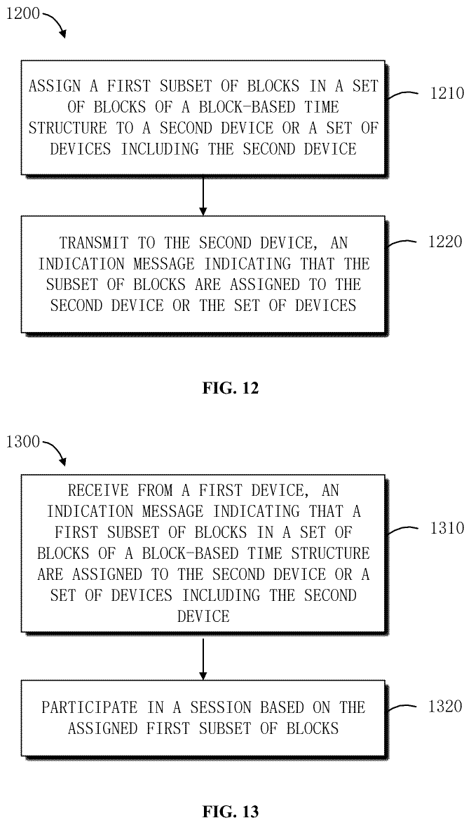

FIG. 12 illustrates an example of a method 1200 implemented at the first device 110 in accordance with some example embodiments of the present disclosure. At block 1210, the first device 110 assigns a first subset of blocks in a set of blocks of a block-based time structure to a second device or a set of devices including the second device. At block 1220, the first device 110 transmitting, to the second device, an indication message indicating that the first subset of blocks is assigned to the second device or the set of devices.

In some embodiments, a position of the first round in a first block in the first subset of blocks is same or different from a position of the second round in a second block in the first or next subset of blocks, and the first round and the second round are allocated to the second device.

In some embodiments, the first subset of blocks and a second subset of blocks are in a first hyper block and a second hyper block respectively, wherein each of the first hyper block and the second hyper block includes a plurality of blocks. A position of the first subset of blocks in the first hyper block is the same as a position of the second subset of blocks in the second hyper block.

In some embodiments, the first device 110 further transmits one or more in the following items to the second device 120 in a first block among the first subset of blocks: an index of a second block among the first or second subset of blocks; or the number of rounds in the second block among the first or second subset of blocks.

In some embodiments, the indication message comprises one or more in the following items: a hyper block index field configured to indicate an index of a hyper block in which the second block is located; a relative block index field configured to indicate a relative index of the second block in the hyper block; a round index field configured to indicate an index of a round in the second block; or a transmission offset field configured to indicate a transmission offset of the round in the second block.

In some embodiments, the first device 110 further transmits to the second device 120, an advertising message in a hyper block. The advertising message advertises block assignment to the set of devices, and the block assignment indicates at least one block in the hyper block allocated to the set of devices.

In some embodiments, the advertising message comprises: addresses of the set of devices that are assigned to the subset of blocks in the hyper block, and the number of rounds in a block in the subset of blocks.

In some embodiments, the advertising message comprises one or more in the following items: a block index field configured to indicate the index of the hyper block; a block description list length field configured to indicate the number of block descriptions in a block description list; or a block description list field configured to carry a list of block description field, each block description field carrying information of one block in the hyper block.

In some embodiments, the block description field comprises one or more in the following items: a control bitmap field configured to carry bits indicating presence or size of the fields of the block description field; a block duration field configured to indicate the duration of the block in a RSTU; a number of rounds field configured to indicate the number of rounds in the block; or a block assignment list configured to indicate a list of block assignments.

In some embodiments, the block assignment comprises one or more in the following items: an address list field configured to indicate a list of address of the second device or set of devices that are allocated one or more round in the block; an address size field configured to indicate the size used for the addresses in the address list; or an address list length field configured to indicate the number of addresses in the address list.

In some embodiments, the first device 110 further transmits a poll message to the second device 120 at an indicated start time to initiate an MMS ranging measurement cycle. The poll message comprises one or more of the following items: a hyper block index field configured to indicate an index of the hyper block in which the second block is located; a relative block index field configured to indicate a relative index of the second block in the hyper block; or a number of rounds field configured to indicate the number of rounds in the block indicated by the relative block index field.

In some embodiments, the first device 110 further transmits an RPRT message carrying a ranging report to the second device 120. The RPRT message further carries control information related to the second block, and the RPRT message comprises one or more items of: a hyper block index field configured to indicate an index of the hyper block in which the second block is located; a relative block index field configured to indicate a relative index of the second block in the hyper block; a block index presence bit configured to indicates whether the hyper block index field and the relative block index fields are present in the RPRT message; a number of rounds presence bit configured to indicate whether a number of rounds field is present in the RPRT message; or the number of rounds field configured to indicate number of rounds in the block indicated by the relative block index field.

In some embodiments, the first device 110 further transmits to the second device 120, a PRM-RESP message, to update short term operating parameters, wherein the PRM-RESP message comprises one or more of: a presence control field configured to carry bits to indicate presence or absence of various fields; a block index presence bit configured to indicates whether a hyper block index field and a relative block index field are present in the PRM-RESP message; a number of rounds presence bit configured to indicate whether a number of rounds field is present in the PRM-RESP message; an operating parameters presence bitmap configured to carry bits to indicate presence or absence of various operating parameters related to a session between the first device and the second device; the hyper block index field configured to indicate an index of the hyper block in which the second block is located; the relative block index field configured to indicate a relative index of the second block in the hyper block; the number of rounds field configured to indicate number of rounds in the block indicated by the relative block index field; or the operating parameters field configured to carry various operating parameters related to a session between the first device and the second device.

In some embodiments, the advertising message comprises one or more of the following items: an address field configured to a broadcast address; a hyper block index field configured to indicate the index of the current hyper block; a block description list configured to carry a list of block description fields, each block description field carrying information of one block of the hyper block; or a block description list length field configured to indicate the number of block description fields in the block description list.

In some embodiments, a block assignment in the block description field comprises one or more items of: an address list field configured to carry a list of short address of the second device or set of devices that are allocated one or more rounds in the block; or an address list length field configured to indicate the number of short addresses in the address list.

In some embodiments, the indication message comprises: an RR IE, including a ranging block index field configured to indicate the second block or the index of any future block, in a signaling between the first device and the second device.

In some embodiments, the first device 110 further transmits to the second device 120, a PRM-RESP message to inform the second block. The PRM-RESP message comprises one or more of the following items: a block index presence bit in a presence control field configured to indicate whether a next block index field is carried in the PRM-RESP message; or the next block index field configured to indicate the index of the second block.

In some embodiments, the method is performed for one or more of the following applications: ranging; sensing; or TDOA.

FIG. 13 illustrates an example of a method 1300 implemented at the second device 120 in accordance with some example embodiments of the present disclosure.

At block 1310, the second device 120 receives from the first device 110, an indication message indicating that a first subset of blocks in a set of blocks of a block-based time structure are assigned to the second device 120 or a set of devices including the second device 120.

At block 1320, the second device 120 participates in a session based on the assigned first subset of blocks.

In some embodiments, a position of the first round in a first block in the first subset of blocks is same or different from a position of the second round in a second block in the first or next subset of blocks, the first round and the second round are allocated to the second device 120.

In some embodiments, the first subset of block and a second subset of blocks are in a first hyper block and a second hyper block respectively, wherein each of the first hyper block and the second hyper block includes a plurality of blocks. A position of the first subset of blocks in the first hyper block is the same as a position of the second subset of blocks in the second hyper block.

In some embodiments, the second device 120 further receives one or more of the following items from the first device 110 in the first block among the first subset of blocks: an index of the second block among the first or second subset of blocks, or the number of rounds in the second block among the first or second subset of blocks. The second device 120 also calculates the position of the round allocated to it in the second block based on the number of rounds in the second block.

In some embodiments, the second device 120 further receives an advertising message in a hyper block from the first device 110. The advertising message advertises block assignment to the set of devices, and the block assignment indicates at least one block in the hyper block allocated to the set of devices.

In some embodiments, the advertising message comprises: addresses of the set of devices that are assigned to the subset of blocks in the hyper block, and the number of rounds in a block in the subset of blocks.

In some embodiments, the second device 120 further receives a poll message from the first device, at an indicated start time to initiate an MMS ranging measurement cycle. The poll message comprises at one or more of the following items: a hyper block index field configured to indicate an index of the hyper block in which the second block is located; a relative block index field configured to indicate a relative index of the second block in the hyper block; or a number of rounds field configured to indicate the number of rounds in the block indicated by the relative block index field.

In some embodiments, the second device 120 further receives from the first device 110, an RPRT message carrying a ranging report from the first device 110, wherein the RPRT message further carries control information related to the second block. The RPRT message comprises one or more in the following items: a hyper block index field configured to indicate an index of the hyper block in which the second block is located; a relative block index field configured to indicate a relative index of the second block in the hyper block; a block index presence bit configured to indicates whether the hyper block index field and the relative block index fields are present in the RPRT message; a number of rounds presence bit configured to indicate whether a number of rounds field is present in the RPRT message; or the number of rounds field configured to indicate number of rounds in the block indicated by the relative block index field.

In some embodiments, the second device 120 further receives from the first device 110, a PRM-RESP message, to update short term operating parameters. The PRM-RESP message comprises one or more of the following items: a presence control field configured to carry bits to indicate presence or absence of various fields; a block index presence bit configured to indicates whether a hyper block index field and a relative block index field are present in the PRM-RESP message; a number of rounds presence bit configured to indicate whether a number of rounds field is present in the PRM-RESP message; an operating parameters presence bitmap configured to carry bits to indicate presence or absence of various operating parameters related to a session between the first device and the second device; the hyper block index field configured to indicate an index of the hyper block in which the second block is located; the relative block index field configured to indicate a relative index of the second block in the hyper block; the number of rounds field configured to indicate number of rounds in the block indicated by the relative block index field; or the operating parameters field configured to carry various operating parameters related to a session between the first device and the second device.

In some embodiments, the method is performed for one or more of the following applications: ranging; sensing; or TDOA.

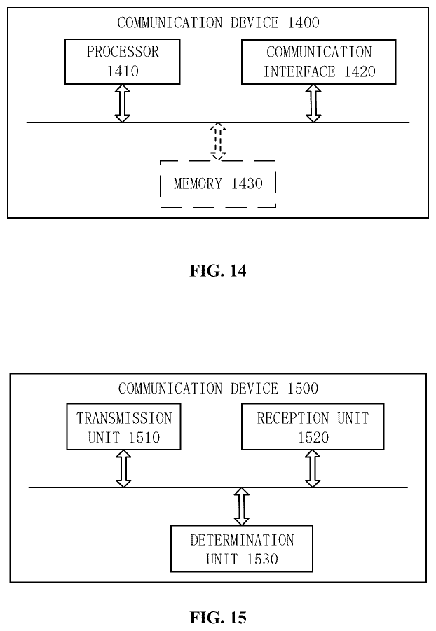

FIG. 14 illustrates a simplified block diagram of a communication device 1400 that is suitable for implementing some example embodiments of the present disclosure. For example, the communication device 1100 may be provided to implement the first device 110, or the second device 120 as shown in FIG. 6.

As shown in FIG. 14, the communication device 1400 includes one or more processors 1410, one or more memories 1430, and one or more communications interfaces 1420. The processor 1410 may be of any type suitable to the local technical network and may include one or more of the following: general purpose computers, special purpose computers, microprocessors, digital signal processors (DSPs) and processors based on multicore processor architecture, as non-limiting examples. The communication device 1400 may have multiple processors, such as an application specific integrated circuit chip that is slaved in time to a clock which synchronizes the main processor.

The memory 1430 may include one or more non-volatile memories and one or more volatile memories. Examples of the non-volatile memories include, but are not limited to, a read-only memory (ROM), an electrically programmable read-only memory (EPROM), a flash memory, a hard disk, a compact disc (CD), a digital video disc (DVD), and other magnetic storage and/or optical storage. Examples of the volatile memories include, but are not limited to, a random-access memory (RAM) and other volatile memories that will not last in the power-down duration.

The communications interface 1420 can be used for bidirectional communications. The communications interface 1420 may have at least one antenna to facilitate communication. The communication interface 1420 may represent any interface that is necessary for communication with other network elements.

The processor 1410 is configured to control the communications interface 1420 to receive and send a signal. The memory 1430 is configured to store a computer program. The processor 1410 is configured to invoke the computer program from the memory 1430 and run the computer program, so that the communication device 1400 is enabled to perform a corresponding procedure and/or operation in various embodiments of the communication methods in this disclosure.

FIG. 15 illustrates another simplified block diagram of a communication device that is suitable for implementing some example embodiments of the present disclosure. As shown in FIG. 15, the communication device 1500 comprises a transmission unit 1510, a reception unit 1520, and a determination unit 1530. When the communication device implements the first device 110, the determination unit 1530 assigns a first subset of blocks in a set of blocks of a block-based time structure to a second device 120 or a set of devices including the second device 120. The transmission unit 1510 transmits to the second device 120, an indication message indicating that the first subset of blocks is assigned to the second device 120 or the set of devices. When the communication device implements the second device 120, the reception unit 1520 receives from the first device 110, an indication message indicating that a first subset of blocks in a set of blocks of a block-based time structure are assigned to the second device 120 or a set of devices including the second device 120. The determination unit 1530 participates in a session based on the assigned first subset of blocks.

A person of ordinary skill in the art may be aware that, in combination with units and algorithm steps of the examples described in the embodiments disclosed in this specification, this disclosure may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for convenient and brief description, for a detailed working process of the foregoing system, apparatus, and unit, refer to a corresponding process in the foregoing method embodiments, and details are not described herein again.

In the several embodiments provided in this disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this disclosure. The foregoing storage medium includes: any medium that can store program code, such as a USB flash drive, a removable hard disk, a ROM, a RAM, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method, comprising:
assigning, at a first device, a first subset of blocks in a first set of blocks of a block-based time structure to a second device or a second set of devices including the second device; and
transmitting, to the second device, an indication message indicating that the first subset is assigned to the second device or the second set.

2. The method of claim 1, wherein a first round in a first block in the first subset and a second round in a second block in the first subset or a next subset of blocks are allocated to the second device.

3. The method of claim 1, wherein the first subset is in a first hyper block, wherein a second subset of blocks is in a second hyper block, wherein each of the first hyper block and the second hyper block includes a plurality of blocks, and wherein a first position of the first subset in the first hyper block is the same as a second position of the second subset in the second hyper block.

4. The method of claim 1, further comprising transmitting, to the second device in a first block among the first subset, at least one of:
a first index of a second block among the first subset or a second subset of blocks; or
a number of first rounds in the second block among the first subset or the second subset.

5. The method of claim 4, wherein the indication message comprises at least one of:
a hyper block index field configured to indicate a second index of a hyper block in which the second block is located;
a relative block index field configured to indicate a relative index of the second block in the hyper block;
a round index field configured to indicate a third index of a second round in the second block; or
a transmission offset field configured to indicate a transmission offset of the second round.

6. The method of claim 3, further comprising transmitting, to the second device, an advertising message in a hyper block, wherein the advertising message advertises a first block assignment to the second set, and wherein the first block assignment indicates at least one block in the hyper block allocated to the second set.

7. The method of claim 6, wherein the advertising message comprises:
addresses of the second set; and
a number of rounds in a block in the first subset.

8. The method of claim 6, wherein the advertising message comprises at least one of:
a block index field configured to indicate an index of the hyper block;
a block description list length field configured to indicate a first number of block descriptions in a block description list; or
a block description list field configured to carry a list of block description fields, wherein each of the block description fields carries information of one block in the hyper block.

9. The method of claim 8, wherein each of the block description fields comprises at least one of:
a control bitmap field configured to carry bits indicating a presence or a size of fields of the block description field;
a block duration field configured to indicate a duration of the one block in a ranging scheduling time unit (RSTU);
a number of rounds field configured to indicate a second number of rounds in the one block; or
a block assignment list configured to indicate a list of second block assignments.

10. A method, comprising:
receiving, at a second device and from a first device, an indication message indicating that a first subset of blocks in a first set of blocks of a block-based time structure is assigned to either the second device or a second set of devices including the second device; and
participating, based on the first subset of blocks, in a first session.

11. The method of claim 10, wherein a first round in a first block in the first subset and a second round in a second block in the first subset or a next subset of blocks are allocated to the second device.

12. The method of claim 10, wherein the first subset is in a first hyper block, wherein a second subset of blocks is in a second hyper block, wherein each of the first hyper block and the second hyper block includes a plurality of blocks, and wherein a first position of the first subset in the first hyper block is the same as a second position of the second subset in the second hyper block.

13. The method of claim 10, further comprising:
receiving, from the first device in a first block among the first subset of blocks, at least one of:
a first index of a second block among the first subset or a second subset of blocks; or
a first number of first rounds in the second block among the first subset or the second subset; and
calculating, at the second device and based on the first number, a position of a round allocated to the second device in the second block.

14. The method of claim 12, further comprising receiving, from the first device, an advertising message in a hyper block, wherein the advertising message advertises a block assignment to the second set, and wherein the block assignment indicates at least one block in the hyper block allocated to the second set.

15. The method of claim 14, wherein the advertising message comprises:
addresses of the second set; and
a number of rounds in a block in the first subset.

16. The method of claim 13, further comprising receiving, from the first device and at an indicated start time to initiate a multi-millisecond (MMS) ranging measurement cycle, a poll message comprising at least one of:
a hyper block index field configured to indicate a second index of a hyper block in which the second block is located;
a relative block index field configured to indicate a relative index of the second block in the hyper block; or
a number of rounds field configured to indicate the first number.

17. The method of claim 16, further comprising receiving, from the first device, a report (RPRT) message carrying a ranging report and control information related to the second block, wherein the RPRT message comprises at least one of:
a first hyper block index field configured to indicate the second index;
a first relative block index field configured to indicate a relative index of the second block in the hyper block;
a first block index presence bit configured to indicate whether the first hyper block index field and the first relative block index field are present in the RPRT message;
a first number of rounds presence bit configured to indicate whether a first number of rounds field is present in the RPRT message; or
the first number of rounds field configured to indicate a second number of rounds in the second block.

18. The method of claim 17, further comprising receiving, from the first device, a parameter response (PRM-RESP) message to update short term operating parameters, wherein the PRM-RESP message comprises at least one of:
a presence control field configured to carry first bits to indicate a presence or an absence of various fields;
a second block index presence bit configured to indicate whether a second hyper block index field and a second relative block index field are present in the PRM-RESP message;
a second number of rounds presence bit configured to indicate whether a second number of rounds field is present in the PRM-RESP message;
an operating parameters presence bitmap configured to carry second bits to indicate a presence or an absence of various operating parameters related to a second session between the first device and the second device;
the second hyper block index field configured to indicate an index of the hyper block;
the second relative block index field configured to indicate the relative index;
the second number of rounds field configured to indicate a third number of rounds in the second block; or
an operating parameters field configured to carry various operating parameters related to a third session between the first device and the second device.

19. A first device comprising:
a communications interface;
a memory configured to store programming instructions; and
at least one processor coupled to the communications interface and the memory and configured to execute the programming instructions to cause the first device to:
assign a first subset of blocks in a first set of blocks of a block-based time structure to a second device or a second set of devices including the second device; and
transmit, by using the communications interface and to the second device, an indication message indicating that the first subset is assigned to the second device or the second set.

20. A second device comprising:
a communications interface;
a memory configured to store programming instructions; and
at least one processor coupled to the communications interface and the memory and configured to execute the programming instructions to cause the second device to:
receive, by using the communications interface and from a first device, an indication message indicating that a first subset of blocks in a first set of blocks of a block-based time structure is assigned to either the second device or a second set of devices including the second device; and
participate, based on the first subset of blocks, in a first session.
